(19) United States
(12) Patent Application Publication
(10) Pub. No.: US 2009/0210306 A1
(43) Pub. Date: Aug. 20, 2009

(54) ADVERTISING METHOD AND SYSTEM USING EXTERNAL MEMORY DEVICE

(75) Inventor: Dae-Seong CHA, Pohang (KR)

Correspondence Address: CANTOR COLBURN, LLP, 20 Church Street, 22nd Floor, Hartford, CT, 06103, US

(73) Assignee: EDEN ENTERPRISE CO., LTD., Pohang (KR)

(21) Appl. No.: 12/188,526

(22) Filed: Aug. 8, 2008

(30) Foreign Application Priority Data
Feb. 18, 2008 (KR) 10-2008-0014648

(51) Int. Cl. G06Q 30/00

(52) U.S. Cl. 705/14

(57) ABSTRACT

Provided are an advertising method and system using an external memory device. A basic advertisement data, access information for an advertisement server, and an ID number of an external memory device is stored in the external memory device that are provided to a user as an advertisement product or a sale promotion product. In a case where the user connects the external memory device to the user terminal of which connection to the Internet is not available, the basic advertisement data is displayed to the user. Accordingly, even in a case where the connection to the Internet is not available, the advertisement can always be displayed to the user. In addition, in a case where the user connects the external memory device to the user terminal of which connection to the Internet is available, the user terminal accesses the advertisement server by using the access information for the advertisement server and transmits the ID number to the advertisement server. The advertisement server examines user information stored in association with the ID number and transmits to the user terminal the advertisement data of which advertisement target is designated to the user so as for the advertisement data to be displayed to the user. Accordingly, target advertisement according to time, age, location, vocation, gender, or the like can be implemented.

### CROSS-REFERENCE TO RELATED PATENT APPLICATION

This application claims the benefit of Korean Patent Application No. 10-2008-0014648, filed on Feb. 18, 2008 in the Korean Intellectual Property Office, the disclosure of which is incorporated herein in its entirety by reference.

### BACKGROUND OF THE INVENTION

1. Field of the Invention

The present invention relates to an advertising method and system, and more particularly, to an advertising method and system using an external memory device.

2. Description of the Related Art

As development of IT (information telecommunication) technologies, various advertising methods have been developed. In conventional advertising methods, signboards are set up on the stores, or leaflets discrediting products are distributed. As the development of the IT technologies, the conventional advertising methods have been replaced with advertising methods using the Internet. For example, an advertiser requests Internet sides to make banner or popup advertisement, so that advertisement banners or popup windows are displayed on user terminals which access to the Internet sites. In addition, an advertiser registers an advertisement keyword in a search site, and if a user searches for the keyword, the user is allowed to be exposed to advertisement associated with the keyword.

However, such an Internet advertising method is limited to advertisement banners, advertisement popup windows, keywords for advertisement, or the like, that the advertiser registers in advance. Therefore, it is difficult to smoothly change the advertisement. In addition, it is difficult to implement target advertisement according to users.

In addition, such an Internet advertising method has a limitation in that the advertisement can be exposed in the only environment that the Internet is connected.

### SUMMARY OF THE INVENTION

The present invention provides an advertising method and system capable of exposing a user to advertisement even in an environment that connection to the Internet is not available.

The present invention also provides an advertising method and system capable of performing target advertisement according to users, that is, according to gender, age, location, or the like of the users.

According to an aspect of the present invention, there is provided an advertising system comprising: an external memory device which stores a basic advertisement data; and a user terminal which, if the external memory device is connected thereto, reads out the advertisement data and output the advertisement data to a user.

In the above aspect, the advertising system may further comprises an advertisement server which stores an advertisement data, wherein the external memory device may further store access information for the advertisement server, and wherein, when the external memory device is connected thereto, the user terminal may read out the access information from the external memory device and access the advertisement server to receive the advertisement data from the advertisement server and to display the advertisement data to the user.

In addition, the external memory device may further store an ID (identification) number, and the advertisement server may store user information of the user who uses the external memory device corresponding to the ID number in association with the ID number.

In addition, when the external memory device is connected thereto, the user terminal may read out the ID number and transmits the ID number to the advertisement server, and wherein the advertisement server may receive target information which defines a user to whom the advertisement data is to be displayed from an advertiser terminal and store the target information in association with the advertisement data, and wherein, when receiving the ID number, the advertisement server may read out the user information stored in association with the ID number and transmit to the user terminal the advertisement data stored in association with the target information which defines the user to whom the advertisement data is to be displayed so as for the advertisement data to be displayed to the user.

In addition, the advertisement server may generate statistical information on the advertisement data that are transmitted to the user terminal and provide the statistical information to the advertiser terminal.

In addition, when the external memory device is connected thereto, the user terminal may determine based on the access information for the advertisement server whether or not access to the advertisement server is available, and wherein, if the access to the advertisement server is determined no to be available, the user terminal may display the basic advertisement data to the user.

According to another aspect of the present invention, there is provided an external memory device comprising: a server information storage unit which stores access information for an advertisement server which a user terminal is to access; an ID number storage unit which stores an ID (identification) number which is stored in association with user information in the advertisement server; a memory controller which, if the external memory device is connected to the user terminal, outputs the access information to the user terminal so as for the user terminal to access the advertisement server by using the access information and transmits the ID number to the user terminal so as for the advertisement server to identify the user information stored in association with the ID number and transmit to the user terminal the advertisement data of which advertisement target is designated to the user; and a program storage unit which stores a program which is to be installed in the user terminal so as for the user terminal to access the advertisement server according to the access information and transmit the ID number to the advertisement server and so as for the user terminal to receive the advertisement data of which advertisement target is designated to the user according to user information stored in association with the ID number and display the advertisement data to the user.

In the above aspect, the external memory device may further comprise an advertisement data storage unit which stores a basic advertisement data, wherein the memory controller may transmit the basic advertisement data to the user terminal so as for the user terminal to output the basic advertisement data in a case where the user terminal cannot access the advertisement server according to the access information.

According to still another aspect of the present invention, there is provided an advertisement server comprising: a user information DB which stores an ID (identification number) of an external memory device in association with user information of a user of the external memory device; an advertisement DB which stores advertisement data in association with target information which defines the user to whom the advertisement data is to be displayed; and an advertisement server controller which, when the external memory device is connected to the user terminal, receives the ID number of the external memory device from the user terminal, reads out the user information of the external memory device, and transmits to the user terminal the advertisement data of which advertisement target is designated to the user so as for the advertisement data to be displayed. In the above aspect, the advertisement server may further comprise a statistical information generating unit which generates statistical information on the advertisement data and stores the statistical information in the advertisement DB.

According to further still another aspect of the present invention, there is provided an advertising method comprising steps of: (a), when an external memory device is connected to a user terminal, the user terminal receiving access information for an advertisement server from the external memory device; (b) the user terminal accessing the advertisement server by using the access information; (c) the advertisement server transmitting an advertisement data to the user terminal; and (d) the user terminal displaying the advertisement data to a user.

In the above aspect, in the step (a), the user terminal may receive an ID (identification) number of the external memory device in association with the access information; in the step (b), the user terminal may access the advertisement server to transmit the ID number to the advertisement server; and in the step (c), the advertisement server may read out user information of the user of the external memory device stored in association with the ID number and transmit to the user terminal an advertisement data of which advertisement target is designated to the user.

In addition, in a case where the user information stored in association with the ID number does not exist, in the step (c), the advertisement server may transmit a user information input page to the user terminal and receive the user information from the user terminal to store the user information in association with the ID number.

In addition, in a case where the user terminal cannot access the advertisement server in the step (b), in the step (d), the user terminal may receive a basic advertisement data from the external memory device and display the basic advertisement data to the user.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a whole configuration of an advertising system according to an embodiment of the present invention;

FIG. 2 is a view showing constructions of an external memory device and a user terminal according to the embodiment of the present invention;

FIG. 3 is a block diagram showing a construction of an advertisement server according to the embodiment of the present invention;

FIGS. 4a and 4b are flowcharts showing an advertising method according to an embodiment of the present invention;

FIG. 5 is a view showing an example of statistical information generated by a statistical information generating unit of an advertisement server according to the embodiment of the present invention; and

FIG. 6 is a view showing an example of advertisement that is displayed to a user according to an embodiment of the present invention.

### DETAILED DESCRIPTION OF THE INVENTION

Hereinafter, exemplary embodiments of the present invention will be described with reference to the accompanying drawings.

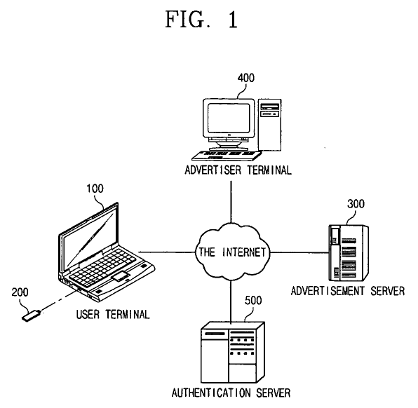

FIG. 1 is a view showing a whole configuration of an advertising system according to an embodiment of the present invention. As shown in FIG. 1, the advertising system of the present invention includes a user terminal 100, an advertisement server 300, an advertiser terminal 400, and an authentication server 500 which are connected through the Internet and an external memory device 200 which is connected to the user terminal 100.

The external memory device 200 includes a data storage area where a user can freely write and remove data and a separate service data storage area which is allocated so as for the user not to write and removes data. The service data storage area stores a program which is to be installed in the user terminal 100 so as to drive a service of the present invention, access information for the advertisement server 300 which is used for the service of the present invention, an ID (identification) number of the external memory device 200, and a basic advertisement data which is to be displayed to the user when access to the advertisement server 300 is not available.

When the external memory device 200 is initially connected to the user terminal 100, the program for driving the service of the present invention is transmitted to the user terminal 100 and installed in the user terminal 100. After installation of the program, every time that the external memory device is connected to the user terminal 100, the access information for the advertisement server and the ID number of the external memory device 200 are transmitted to the user terminal 100.

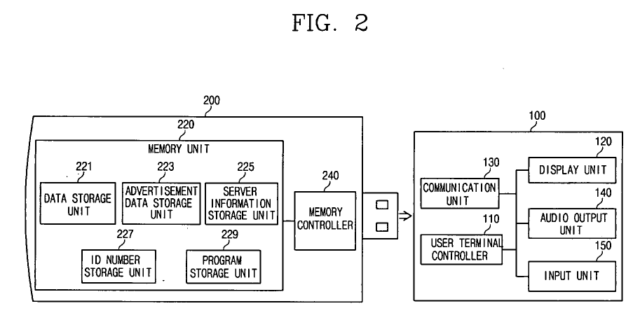

In general, the external memory device 200 may be a USB memory devices, a SD memory card, or the like, that can be conveniently carried. Detailed functions of the external memory device 200 will be described later with reference to FIGS. 2 to 4.

When the external memory device 200 is connected, the user terminal 100 installs the program received from the external memory device 200 therein. Every time that the external memory device 200 is connected, the user terminal receives from the external memory device 200 the access information for the advertisement server 300 and the ID number of the external memory device. The user terminal accesses the advertisement server 300 by using the access information for the advertisement server 300 to transmit the ID number of the external memory device.

In addition, in a case where the user information is not registered, the user terminal 100 receives a user information registration page from the advertisement server 300 to display the page to the user. The user terminal receives user personal information input by the user and transmits the information to the advertisement server 300 so as to register the user information. After the user information is registered, the user terminal receives an advertisement data of which advertisement target is designated to the user and displays the advertisement data to the user.

The advertisement server 300 stores the ID number of the external memory device 200 and the user personal information of the user who uses the external memory device 200 corresponding to the ID number. In addition, the advertisement server stores the advertisement data received from the advertiser terminal 400.

In addition, the advertisement server 300 examines the ID number of the external memory device 200 received from the user terminal 100 to check personal information such as age and gender of the user. The advertisement server transmits the advertisement data of the advertiser who designates the user as a target to the user terminal 100 to display the advertisement data thereon. The advertisement server counts the display times (advertisement exposure times) of the advertisement data which is displayed on the user terminal 100 to generate statistical information on the advertisement exposure times or the like.

The advertiser terminal 400 transmits to the advertisement server 300 the advertisement data and the target information which defines the user to whom the advertisement data is to be displayed. In addition, the advertiser terminal receives from the advertisement server 300 the statistical information on the advertisement exposure times for the advertisement data of the advertiser.

The authentication server 500 authenticates the user by using name and social security number of the user which are received from the user terminal 100 or the advertisement server 300. The authentication server transmits a result of the authentication to the user terminal 100.

FIG. 2 is a view showing constructions of the external memory device 200 and the user terminal 100 according to the embodiment of the present invention. Referring to FIG. 2, the external memory device 200 includes a memory unit 220 and a memory controller 240. The memory unit 220 includes a data storage unit 221, an advertisement data storage unit 223, a server information storage unit 225, an ID number storage unit 227, and a program storage unit 229. However, it should be noted that the storage units included in the memory unit 220 is not physically-divided components but conceptually-divided components.

The data storage unit 221 is a data storage area which the user can freely write and remove data after the registration of the user information. The other storage units are data storage areas which are protected so that the user cannot arbitrarily write and remove data.

The advertisement data storage unit 223 stores a basic advertisement data which is to be displayed to the user in a situation that the user terminal 100 cannot access the advertisement server 300 through the Internet. The basic advertisement data is a data which is recorded during the time of manufacturing the external memory device 200 or before distribution thereof so as not to be modified or so as to be automatically updated every time that the user access the advertisement server 300.

The server information storage unit 225 stores the access information for accessing the advertisement server 300. The access information for the advertisement server 300 may be an IP address of the advertisement server 300.

The ID number storage unit 227 stores the ID number which is allocated to the external memory device 200. The program storage unit 229 stores the program which is to be installed in the user terminal 100 so as to drive the service of the present invention.

The memory controller 240 controls the whole functions of the external memory device 200. More specifically, the memory controller controls the whole functions performed in the USB memory device, the SD memory card, or the like, for example, a data writing function and a data removing function. In addition, when the external memory device 200 is initially connected to the user terminal 100, the memory controller reads out the program from the program storage unit 229 and transmits the program to the user terminal 100 so as to install the program. After that, when the external memory device 200 is connected to the user terminal 100, the memory controller reads out the access information for advertisement server and the ID number of external memory device from the server information storage unit 225 and the ID number storage unit 227, respectively, and transmits the access information for the advertisement server and the ID number of the external memory device to the user terminal 100.

The user terminal 100 includes a display unit 120, an audio output unit 140, an input unit 150, a user terminal controller 110, and a communication unit 130 (hereinafter, referred to as a first communication unit). The display unit 120 may be a general display apparatus such as a CRT and an LCD, which displays the advertisement data as a video.

The audio output unit 140 outputs audio data such as acoustic data or sound data contained in the advertisement data through a speaker or the like. The input unit 150 is constructed with a keyboard, a mouse, a stylus, or the like to receive the user information as an input.

The first communication unit 130 accesses the advertisement server 300 and the authentication server 500 through the Internet and communicates therewith.

The user terminal controller 110 accesses the advertisement server 300 through the first communication unit 130 by using the access information for the advertisement server 300 received from the external memory device 200. After receiving the user information input page and the advertisement data, the user terminal controller outputs the user information input page and the advertisement data to the display unit 120 so as to display the user information input page and the advertisement data to the user. The user terminal controller transmits the user information input through the input unit 150 and the ID number received from the external memory device 200 to the advertisement server 300.

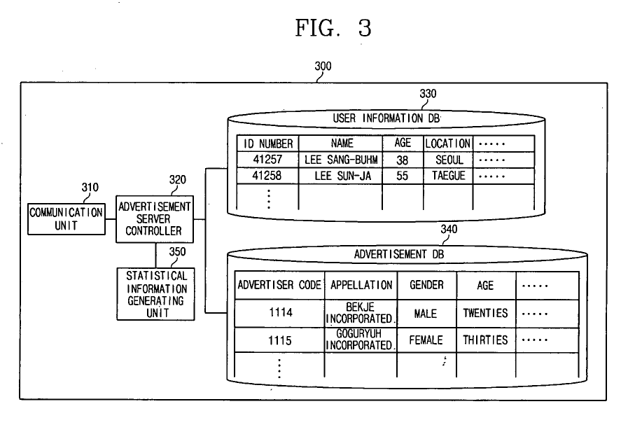

FIG. 3 is a block diagram showing a construction of the advertisement server 300 according to the embodiment of the present invention. Referring to FIG. 3, the advertisement server 300 includes a communication unit 310, an advertisement server controller 320, a statistical information generating unit 350, a user information DB 330, and an advertisement DB 340.

The communication unit 310 (hereinafter, referred to as a second communication unit) communicates with a plurality of the user terminals 100 and a plurality of the advertiser terminals 400 through the Internet.

The statistical information generating unit 350 examines the exposure times of the advertisement data transmitted to the user terminal 100 to generate statistical information according to the advertisers and the advertisement data and stores the advertisement exposure times in the advertisement DB 340.

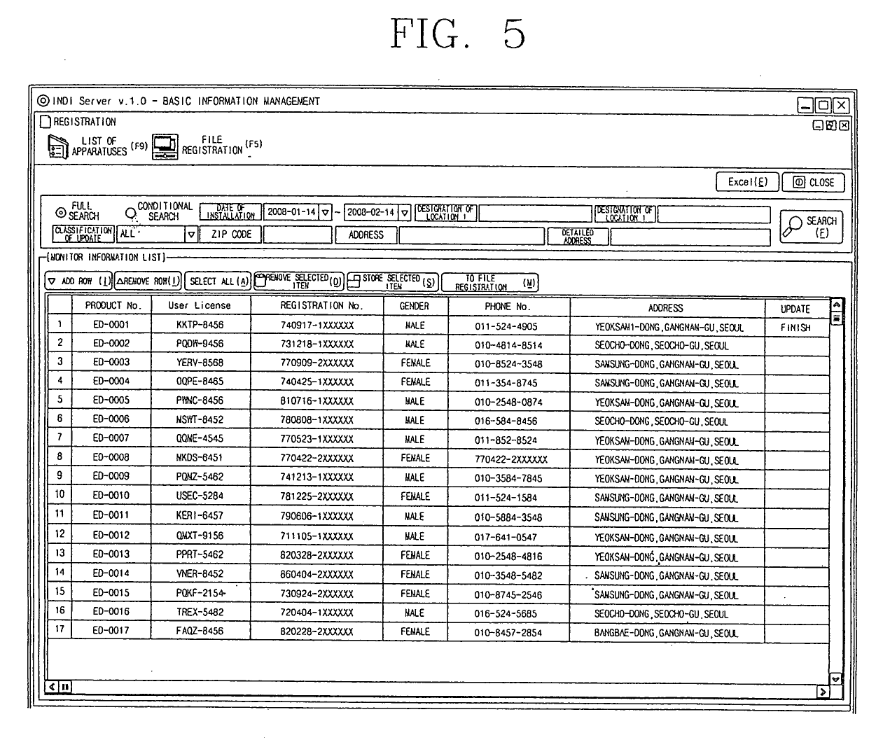

FIG. 5 is a view showing an example of the statistical information generated by the statistical information generating unit 350 according to the embodiment of the present invention.

As shown in FIG. 5, every time that the user connects the external memory device 200 to the user terminal 100 so that the advertisement is displayed on the user terminal 100, the advertisement exposure times is recorded. Therefore, the advertiser can analyze the advertisement exposure history according to the users, so that the advertiser can directly check an effect of the repetitive advertisement exposure.

The user information DB 330 stores the ID numbers of the external memory devices 200 that can be used for the service of the present invention in association with personal information (for example, name, gender, age, address (location), and the like) of the users using the external memory devices.

The advertisement DB 340 stores advertiser information (for example, ID information (advertiser code)), name, address, and the like) of the advertisers, advertisement data information of the advertisers, and the statistical information on the advertisement data.

An example of a data structure stored in the user information DB 330 and a data structure stored in the advertisement DB 340 is shown in FIG. 3. However, it should be noted that the user information and the advertisement data may be stored in various structures.

The advertisement server controller 320 searches for the ID number transmitted from the user terminal 100 through the second communication unit 310 in the user information DB 330 so as to determine whether or not the user information of the user who currently uses the external memory device 200 is registered. If the user information is not registered, the advertisement server controller transmits the user information input webpage to the user terminal 100. After receiving the user information from the user terminal 100, the advertisement server controller stores the user information in association with the ID number in the user information DB 330.

In addition, the advertisement server controller 320 stores the advertisement data received from the advertiser terminal 400 together with the target information for the to-be-transmitted advertisement data in the advertisement DB 340. After receiving the ID number from the user terminal 100, the advertisement server controller searches the user information DB 330 so as to read out the user information that is associated with the ID number. The advertisement server controller reads out the advertisement data of the advertiser who designates the user as an advertisement target from the advertisement DB 340 and transmits the advertisement data to the user terminal 100 to display the advertisement data.

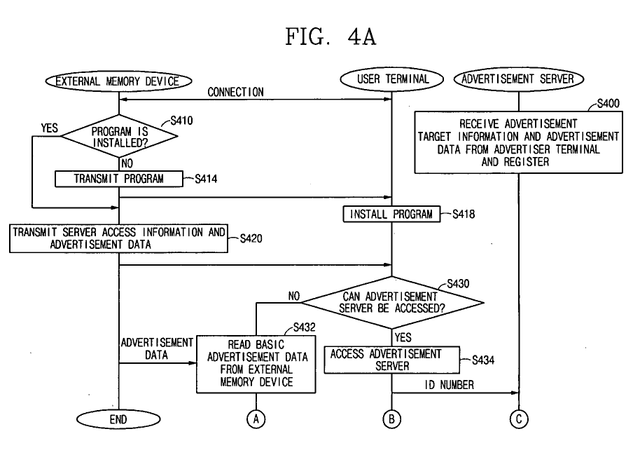

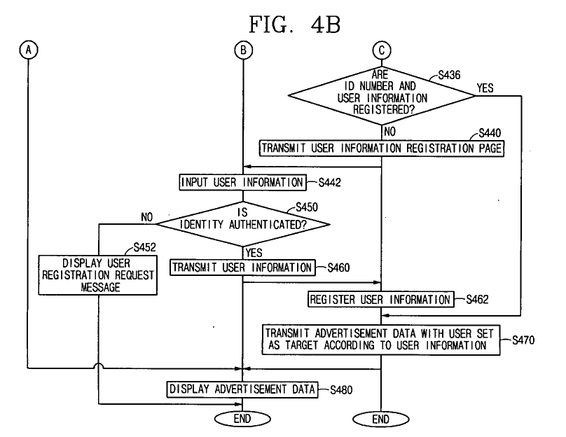

Hereinbefore, the configuration of the advertising system according to the embodiment of the present invention is described. Hereinafter, an advertising method according to an embodiment of the present invention will be described with reference to FIGS. 4A and 4B.

Firstly, the advertisement server 300 receives from the advertiser terminal 400 the advertisement data and the target information which defines age, gender, location, and the like of the user to whom the advertisement data is to be displayed and stores the advertisement data and the target information in the advertisement DB 340 (S400). It should be noted that the step S400 is continuously performed during the later-described processes.

When the user connects the external memory device 200 to the user terminal 100, the external memory device 200 determines whether or not the program executing the service of the present invention is installed in the user terminal 100 (S410). If the program is not installed in the user terminal 100, the external memory device reads out the program stored therein and transmits the program to the user terminal 100 (S414). The user terminal 100 that receives the program installs the program therein (S418).

On the other hand, if the program is determined to be previously installed in the user terminal 100 in the step S410, the external memory device 200 reads out the access information for the advertisement server 300 and the ID number stored therein and transmits the access information and the ID number to the user terminal 100 (S420). The user terminal 100 checks whether or not access to the advertisement server 300 through the Internet is available (S430). If the access to the advertisement server 300 is determined not to be available, the user terminal reads out the basic advertisement data from the external memory device (S432) and displays the read-out advertisement data to the user (S480).

The case where the access to the advertisement server 300 is not available denotes a case where the user terminal 100 is not connected to the Internet and a case where the user terminal 100 that is connected to the Internet cannot access the advertisement server 300 for some problems.

If the access to the advertisement server 300 through the Internet is determined to be available in the step S430, the user terminal 100 access the advertisement server 300 and transmits the ID number of the external memory device 200 to the advertisement server 300 (S434). The advertisement server 300 that receives the ID number searches the user information DB 330 so as to determine whether or not the user information associated with the ID number is registered. If the user information is determined not to be registered, the step S440 proceeds, and if the user information is determined to be registered, the step S470 proceeds (S436).

The case where the user information is determined not to be registered in the step S436 corresponds to the case where the external memory device 200 is firstly used. In this case, the advertisement server 300 transmits the user information registration page to the user terminal 100 (S440). The user terminal 100 displays the page to the user so as for the user to input personal information such as name, social security number, address, age, and the like (S442).

Next, the user terminal 100 transmits the name and social security number input by the user to the authentication server 500 so as to authenticate identity of the user (S450). If the identity of the user is determined not to be authenticated, the user terminal displays the user registration request message to the user, and after that, the user terminal ends the use of the external memory device 200 or proceeds to the aforementioned step S442 (S452).

If the identity of the user is determined to be authenticated, the user terminal 100 transmits the user information input by the user to the advertisement server 300 (S460). The advertisement server 300 registers the received user information in association with the ID number in the user information DB 330 (S462).

On the other hand, in a case where the user information is newly registered in the step S462 or in a case where the user information is previously registered in the aforementioned S436, the advertisement server 300 reads out the user information from the user information DB 330. The advertisement server examines the target information stored in association with the advertisement data in the advertisement DB 340 to read out the advertisement data of which advertisement target is designated to the user and transmits the advertisement data to the user terminal 100 (S470).

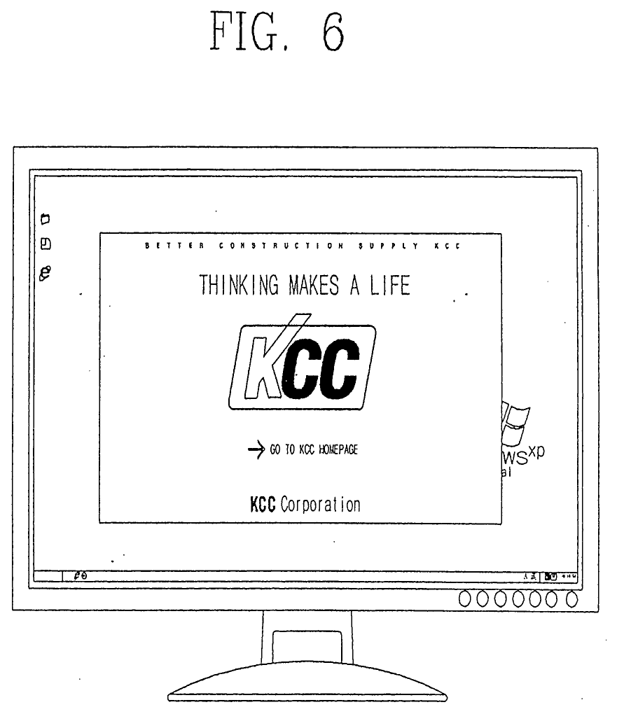

As shown in FIG. 6, when the user terminal 100 receives the advertisement data from the advertisement server 300, the user terminal displays the advertisement data to the user in various formats (S480). FIG. 6 shows an example of the advertisement data that is displayed in a format of a popup window including a link of a homepage of the advertiser. In addition, other various formats of the advertisement data can be displayed.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

In the present invention, a basic advertisement data, access information for an advertisement server, and an ID number of an external memory device is stored in the external memory device that are provided to a user as an advertisement product or a sale promotion product. According to the present invention, in a case where the user connects the external memory device to the user terminal of which connection to the Internet is not available, the basic advertisement data is displayed to the user. Accordingly, there is an advantageous effect in that, even in a case where the connection to the Internet is not available, the advertisement can always be displayed to the user.

In addition, according to the present invention, in a case where the user connects the external memory device to the user terminal of which connection to the Internet is available, the user terminal accesses the advertisement server by using the access information for the advertisement server and transmits the ID number to the advertisement server. The advertisement server examines user information stored in association with the ID number and transmits to the user terminal the advertisement data of which advertisement target is designated to the user so as for the advertisement data to be displayed to the user. Accordingly, there is an advantageous effect in that target advertisement according to time, age, location, vocation, gender, or the like can be implemented.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An advertising system comprising:
an external memory device which stores a basic advertisement data; and
a user terminal which, if the external memory device is connected thereto, reads out the advertisement data and output the advertisement data to a user.

2. The advertising system of claim 1, further comprising an advertisement server which stores an advertisement data,
wherein the external memory device further stores access information for the advertisement server, and
wherein, when the external memory device is connected thereto, the user terminal reads out the access information from the external memory device and accesses the advertisement server to receive the advertisement data from the advertisement server and to display the advertisement data to the user.

3. The advertising system of claim 2,
wherein the external memory device further stores an ID (identification) number, and
wherein the advertisement server stores user information of the user who uses the external memory device corresponding to the ID number in association with the ID number.

4. The advertising system of claim 3,
wherein, when the external memory device is connected thereto, the user terminal reads out the ID number and transmits the ID number to the advertisement server, and
wherein the advertisement server receives target information which defines a user to whom the advertisement data is to be displayed from an advertiser terminal and stores the target information in association with the advertisement data, and
wherein, when receiving the ID number, the advertisement server reads out the user information stored in association with the ID number and transmits to the user terminal the advertisement data stored in association with the target information which defines the user to whom the advertisement data is to be displayed so as for the advertisement data to be displayed to the user.

5. The advertising system of claim 2, wherein the advertisement server generates statistical information on the advertisement data that are transmitted to the user terminal and provides the statistical information to the advertiser terminal.

6. The advertising system of claim 2,
wherein, when the external memory device is connected thereto, the user terminal determines based on the access information for the advertisement server whether or not access to the advertisement server is available, and
wherein, if the access to the advertisement server is determined no to be available, the user terminal displays the basic advertisement data to the user.

7. An external memory device comprising:
a server information storage unit which stores access information for an advertisement server which a user terminal is to access;
an ID number storage unit which stores an ID (identification) number which is stored in association with user information in the advertisement server;
a memory controller which, if the external memory device is connected to the user terminal, outputs the access information to the user terminal so as for the user terminal to access the advertisement server by using the access information and transmits the ID number to the user terminal so as for the advertisement server to identify the user information stored in association with the ID number and transmit to the user terminal the advertisement data of which advertisement target is designated to the user; and
a program storage unit which stores a program which is to be installed in the user terminal so as for the user terminal to access the advertisement server according to the access information and transmit the ID number to the advertisement server and so as for the user terminal to receive the advertisement data of which advertisement target is designated to the user according to user information stored in association with the ID number and display the advertisement data to the user.

8. The external memory device of claim 7, further comprising an advertisement data storage unit which stores a basic advertisement data,
wherein the memory controller transmits the basic advertisement data to the user terminal so as for the user terminal to output the basic advertisement data in a case where the user terminal cannot access the advertisement server according to the access information.

9. An advertisement server comprising:
a user information DB which stores an ID (identification number) of an external memory device in association with user information of a user of the external memory device;
an advertisement DB which stores advertisement data in association with target information which defines the user to whom the advertisement data is to be displayed; and
an advertisement server controller which, when the external memory device is connected to the user terminal, receives the ID number of the external memory device from the user terminal, reads out the user information of the external memory device, and transmits to the user terminal the advertisement data of which advertisement target is designated to the user so as for the advertisement data to be displayed.

10. The advertisement server of claim 9, further comprising a statistical information generating unit which generates statistical information on the advertisement data and stores the statistical information in the advertisement DB.

11. An advertising method comprising steps of:
(a) when an external memory device is connected to a user terminal, the user terminal receiving access information for an advertisement server from the external memory device;
(b) the user terminal accessing the advertisement server by using the access information;
(c) the advertisement server transmitting an advertisement data to the user terminal; and
(d) the user terminal displaying the advertisement data to a user.

12. The advertising method of claim 11,
wherein, in the step (a), the user terminal receives an ID (identification) number of the external memory device in association with the access information,
wherein, in the step (b), the user terminal accesses the advertisement server to transmit the ID number to the advertisement server, and
wherein, in the step (c), the advertisement server reads out user information of the user of the external memory device stored in association with the ID number and transmits to the user terminal an advertisement data of which advertisement target is designated to the user.

13. The advertising method of claim 12, wherein, in a case where the user information stored in association with the ID number does not exist, in the step (c), the advertisement server transmits a user information input page to the user terminal and receives the user information from the user terminal to store the user information in association with the ID number.

14. The advertising method of claim 11, wherein, in a case where the user terminal cannot access the advertisement server in the step (b), in the step (d), the user terminal receives a basic advertisement data from the external memory device and displays the basic advertisement data to the user.

15. A computer-readable medium having embodied thereon program codes for the advertising method of claim 11.

16. A computer-readable medium having embodied thereon program codes for the advertising method of claim 12.

17. A computer-readable medium having embodied thereon program codes for the advertising method of claim 13.

18. A computer-readable medium having embodied thereon program codes for the advertising method of claim 14.
